(19) United States
(12) Patent Application Publication
(10) Pub. No.: US 2025/0290554 A1
(43) Pub. Date: Sep. 18, 2025

(54) ADJUSTABLE DAMPING VALVE DEVICE FOR A VIBRATION DAMPER

(71) Applicant: ZF Friedrichshafen AG, Friedrichshafen (DE)

(72) Inventor: Steffen HEYN, Niederwerrn (DE)

(21) Appl. No.: 19/076,587

(22) Filed: Mar. 11, 2025

(30) Foreign Application Priority Data
Mar. 18, 2024 (DE) 10 2024 202 481.3

(51) Int. Cl. F16F 9/46; F16F 9/34

(52) U.S. Cl. CPC F16F 9/465; F16F 9/34; F16F 2222/12; F16F 2228/066; F16F 2230/183

(57) ABSTRACT

An adjustable damping valve device for a vibration damper includes a pilot stage valve for hydraulic control of a main stage valve. The damping valve device has a check valve arrangement for the rectification of a control volume flow proceeding from working chambers of vibration damper to the pilot stage valve and is characterized in that a pilot stage valve body of the pilot stage valve has a first pressurized surface Di for an incident flow from a first working chamber and a second pressurized surface D₂ for an incident flow from second working chamber.

### BACKGROUND OF THE INVENTION

### 1. Field of the Invention

The disclosure is directed to an adjustable damping valve device for a vibration damper.

### 2. Description of Related Art

DE 44 18 972 A1 is directed to an adjustable damping valve device that comprises a valve housing at a piston rod of a vibration damper. The functional advantage of this damping valve is the use of an individual pilot stage valve for an actuation of a main stage valve with an incident flow proceeding from a working chamber on the piston rod side and from a working chamber remote of the piston rod.

For this purpose, the damping valve device has a total of four check valves that provide for the rectification of a volume flow proceeding from the working chamber on the piston rod side and from the working chamber remote of the piston rod to the pilot stage valve and for the flow-off from the rear chamber of the pilot stage valve to the two working chambers. The check valves switching the inflow are constructed at or in the main stage valve body.

The rectification of the volume flow for the pilot stage valve also entails adapting the operating behavior of the entire damping valve device because the pilot stage valve also acts on a common main stage valve. Although pressurized surfaces of different size can be provided at the main stage valve for the two incident flow directions from the working chambers, the damping force ratio of pull direction to push direction that can be achieved in this way is not sufficient for some applications.

### SUMMARY OF THE INVENTION

It is an object of one aspect of the present invention to implement a damping valve device with a pilot stage valve that is active for both working directions of the vibration damper and in which the damping force ratio is to be increased during alternating incident flow at the damping valve device.

A pilot stage valve body of the pilot stage valve has a first pressurized surface for an incident flow from the working chamber on the piston rod side and a second pressurized surface for an incident flow from the working chamber remote of the piston rod.

The use of different pressurized surfaces at the pilot stage valve ensures a basic asymmetry of the damping forces which can easily be determined by the surface area ratio of the two pressurized surfaces.

With respect to a simple basic construction of the damping valve device, the first pressurized surface and the second pressurized surface are loaded in total during an incident flow proceeding from one of the two working chambers.

A further measure for achieving the asymmetry of the damping force levels consists in that the pilot stage valve has a first control chamber for the first pressurized surface and a second control chamber for the second pressurized surface, which control chambers are hydraulically separated. The operating behavior of the pilot stage valve and, therefore, the main stage valve can be additionally influenced by a selective pressure control inside of the control chambers.

The pilot stage valve body preferably has a step profile, and a step forms the first pressurized surface. For example, an end face of the pilot stage valve can function as the second pressurized surface.

A further measure for simplifying the flow paths within the damping valve device consists in separating the first control chamber and second control chamber by a check valve which blocks a flow from the first control chamber to the second control chamber.

In a further constructional configuration, the two working chambers have a separate flow connection with at least one choke to the connected control chamber. The two choke points preferably have a different degree of restriction. The lower the degree of restriction, the greater the pressure in the control chamber of the pilot stage valve, as a result of which, in turn, the opening force on the pilot stage valve increases, whereupon, in combination with a reduced hydraulic closing force on the main stage valve, a softer damping force characteristic is achieved.

According to an advantageous aspect, a first flow connection from the first working chamber to the pilot stage valve has at least two chokes in series. A first choke of the two chokes is connected to a control line between the pilot stage valve and the main stage valve. By using two chokes, the hydraulic closing force characteristic at the main stage valve body and the hydraulic opening force characteristic at the pilot stage valve body are dimensioned separately.

A further option for determining the damping force characteristic of the damping valve device consists in that the second control chamber is connected choke-free to the second working chamber. Accordingly, the two control chambers can be supplied with different pressure levels with a common incident flow direction and accordingly make use of a further adjusting parameter at the pilot stage valve.

The lift behavior of the pilot stage valve during an incident flow from the first working chamber can also be influenced in that the second control chamber is refilled from the second working chamber via the choke of the second flow path. The choke inside of the second flow path opposes the lift force in the first control chamber via a reduced pressure in the second control chamber.

In an alternative construction, the first control chamber is connected to the second control chamber on the downstream side via a re-flow channel, which re-flow channel has a check valve opening in direction of the second control chamber. This constructional form provides for a sufficient re-flow into the second control chamber regardless of the connection of the second control chamber to the second working chamber. In this way, also, pressure ratios in the second working chamber have no effect at all on the re-flowing of damping medium into the second control chamber.

In a further variant, it is provided that the two flow connections have a first choke for the control line to the main stage valve and a second choke for the pilot stage valve. This provides an even greater range of adjustments for configuring the damping valve device.

On the other hand, the two flow connections of the two working chambers to the first control chamber of the pilot stage valve can be connected at a common second choke in order to simplify the construction of the damping valve device.

### BRIEF DESCRIPTION OF THE DRAWINGS

The invention will be described in more detail referring to the following description of the drawings.

The drawings show:

FIG. 1 is a damping valve device with a pilot stage valve with separate pressurized surfaces for each incident flow direction;

FIG. 2 is a pilot stage valve with pre-choke at different pressure chambers;

FIG. 3 is a pilot stage valve according to the FIG. 2 with choke-free re-flow function;

FIG. 4 is a pilot stage valve with two chokes connected in series;

FIG. 5 is a pilot stage valve according to FIG. 4 with choke-free re-flow function; and

FIG. 6 is a pilot stage valve according to FIG. 4.

### DETAILED DESCRIPTION OF THE PRESENTLY PREFERRED EMBODIMENTS

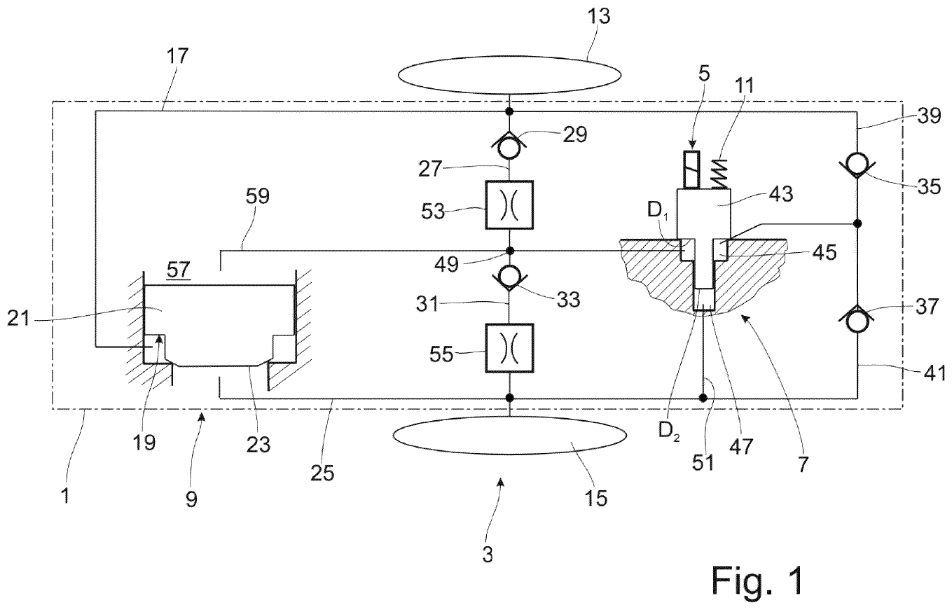

FIG. 1 shows a hydraulic circuit diagram with an adjustable damping valve device 1 as component for a vibration damper 3. The damping valve device 1 can be connected inside of the vibration damper 3, e.g., to a piston rod or as a base valve, but can also be connected externally via a connection piece or hose connections. The damping valve device 1 comprises a pilot stage valve 7, which can be actuated by an actuator 5 for the hydraulic control of a main stage valve 9. At least one return spring 11 pretensions the pilot stage valve in a defined initial operating position. The main stage valve 9 constitutes a hydraulic separation between a first working chamber 13 and a second working chamber 15. The first working chamber 13 cooperates via a first damping medium channel 17 with an annular first pressurized surface 19 of a main stage valve body 21. A second pressurized surface 23 of the main stage valve body is loaded via a second damping medium channel 25 of the second working chamber 15. When the main stage valve 9 is open, the two working chambers 13; 15 are connected to one another via the two damping medium channels 17; 25. Preferably, working chamber 13 is compressed during a rebound motion of the vibration damper 3 and working chamber 15 is compressed during a jounce motion of the vibration damper 3.

Further, the damping valve device 1 has a check valve arrangement for the rectification of a control volume flow proceeding from the working chambers 13; 15 of the vibration damper 3 to the common pilot stage valve 7. A first check valve 29 which opens in flow direction to the pilot stage valve 7 is arranged inside of a first flow connection 27 between the first working chamber 13 and the pilot stage valve 7. A second flow connection 31 between the second working chamber 15 and the pilot stage valve 7 has a second check valve 33, which likewise opens to the pilot stage valve 7 during an incident flow proceeding from the second working chamber 15. A third check valve 35 and a fourth check valve 37 are arranged in a first flow-off line 39 and a second flow-off line 41 from the pilot stage valve 7 to the two working chambers 13; 15. Both the third check valve 35 and the fourth check valve 37 open during an outgoing flow from the pilot stage valve 7 to the two working chambers 13; 15 and blocks in the opposite flow direction.

A pilot stage valve body 43 of the pilot stage valve 7 has a first pressurized surface D₁ for an incident flow from the first working chamber 13 and a second pressurized surface D₂ for an incident flow exclusively from the second working chamber 15. The two pressurized surfaces D₁ and D₂ have a different surface area. The product of the pressure on the surfaces D₁ and D₂ and the surface area of the two surfaces gives a flow-direction-dependent lift force on the pilot stage valve 7.

The pilot stage valve 7 has a first control chamber 45 for the first pressurized surface D₁ and a second control chamber 47 for the second pressurized surface D₂, the first control chamber 45 and second control chamber 47 being hydraulically separated. The pilot stage valve body 43 has, by way of example, a step profile, and a step forms the first pressurized surface D₁. An end face of the pilot stage valve body 43 forms the second pressurized surface D₂ and a closure for the second control chamber 47.

During an incident flow proceeding from the first working chamber 13, only the first pressurized surface D₁ is loaded via the first flow connection 27, and during an incident flow proceeding from the second working chamber 15 the first pressurized surface D₁ and second pressurized surface D₂ in total are loaded, since the second flow connection 31 opens into a port 49 in the first flow connection 27, and a third flow connection 51 is provided between the second working chamber 15 and the second control chamber 47. The third flow connection 51 can open into the second flow-off line 41 or directly into the second working chamber 15.

In addition to the two different pressurized surfaces D₁; D₂ for each incident flow direction, a further adjustment possibility consists in the use of a choke 53; 55 inside of the first flow connection 27 and second flow connection 31. The two chokes 53; 55 are arranged in each instance between one of the working chambers 13; 15 and the port 49 and accordingly influence the pressure level in the first control chamber 45 of the pilot stage valve 7 and the pressure level in a control chamber 57 of the main stage valve 9. This drawing shows that the check valve 29; 33 can be upstream or downstream hydraulically in series in flow direction to the first control chamber 45 of the respective choke 53; 55 inside of the flow connection 27; 31.

The first control chamber 45 is connected via a control line 59 to the port 49 with which the two flow connections 27; 31 are also coupled and to the control chamber 57 of the main stage valve 9. The pressure level in the first control chamber 45 of the pilot stage valve 7 accordingly determines the pressure level in the control chamber 57 of the main stage valve 9.

During an incident flow at the damping valve device 1 proceeding from the first working chamber 13, the first pressurized surface 19 at the main stage valve body 21 is acted upon via the first damping medium channel 17, and the first control chamber 45 of the pilot stage valve 7 is acted upon via the first flow connection 27 when the first check valve 29 is open in connection with the choke 53. Depending on the actuation of the actuator 5, a resulting lift force occurs which is co-determined, inter alia, by the size of the first pressurized surface D₁ at the pilot stage valve body 43. The second closed check valve 33 prevents a hydraulic short circuit in the second working chamber 15.

The second control chamber 47 which increases during the lift movement of the pilot stage valve 7 can be refilled with damping medium from the second working chamber 15 choke-free via the third flow connection 51.

During an incident flow at the damping valve device 1 proceeding from the second working chamber 15, the second pressurized surface 23 at the main stage valve body 21 is downstream of the flow in lift direction via the second damping medium channel 25. Damping medium flows hydraulically parallel via the choke 55 in the second flow connection 31 and via the open second check valve 33 through the port 49 into the first control chamber 45 of the pilot stage valve 7. Simultaneously, the second control chamber 47 of the pilot stage valve 7 is acted upon choke-free via the third flow connection 51. The choke-free incident flow of the second control chamber 47 causes an appreciable increase in the lift force for the pilot stage valve 7. Consequently, an appreciably greater hydraulic lift force acts on the pilot stage valve 7 at the identical initial pressure inside of the second working chamber 15. The third check valve 35 and the fourth check valve 37 in the flow-off lines 39; 41 prevent a flow around the pilot stage valve 7 during an incident flow proceeding from one of the working chambers 13; 15.

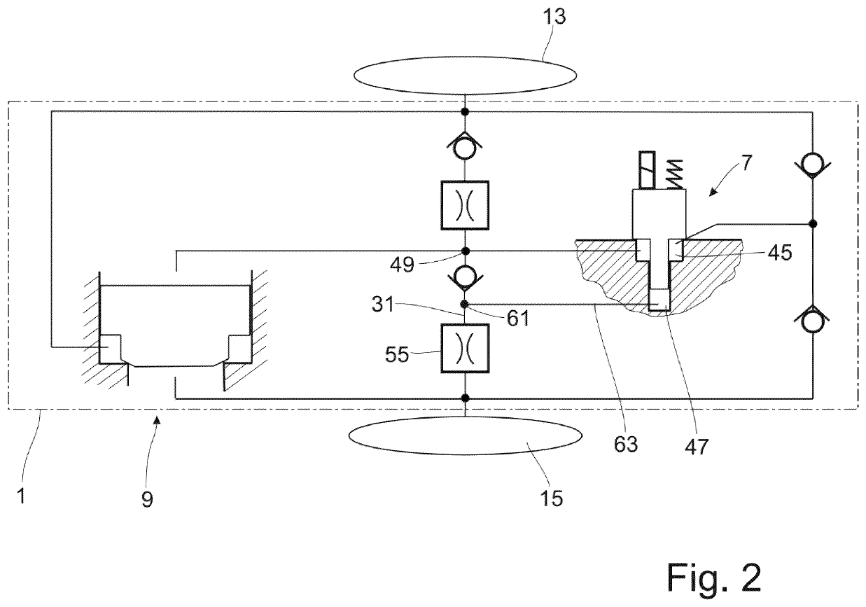

The construction of the damping valve device 1 according to FIG. 2 is based on the damping valve device 1 according to FIG. 1. In contrast, the second flow connection 31 has, in addition to the first port 49, a second port 61 which connects the second flow connection 31 via a bypass connection 63 at the second control chamber 47 of the pilot stage valve 7. The second port 61 is downstream of choke 55 in flow direction to the second control chamber 47. Consequently, the two control chambers 45; 47 are acted upon by the same pressure. Compared with the construction according to FIG. 1, the damping valve device 1 develops a smaller lift force at the pilot stage valve 7 during an incident flow proceeding from the second working chamber 15 with the same excitation of the vibration damper because of the pressure gradient at the first choke 55 before the bypass connection 63. Consequently, at the main stage valve 9, the closing force in the control chamber 57 of the main stage valve 9 tends to be greater with the same pressure in the second working chamber 15, i.e., on the whole, a greater damping force is achieved at the main stage valve 9.

In an incident flow direction from the first working chamber 13, the second control chamber 47 must be filled during a lift movement via the inflow through the choke 55. Accordingly, the lift movement of the pilot stage valve 7 is retarded or damped in this incident flow direction particularly after a change in the incident flow direction.

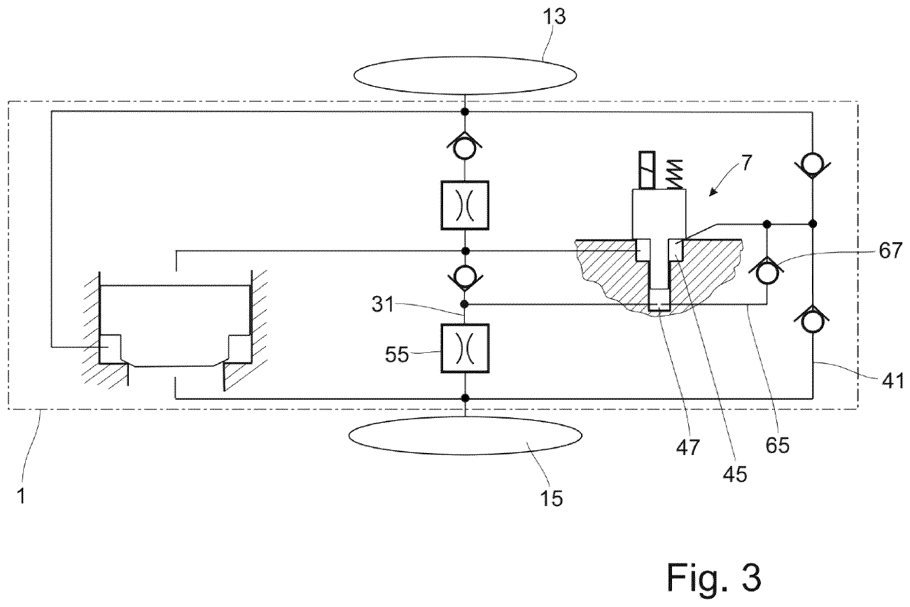

The damping valve device 1 according to FIG. 3 is again based on the construction according to FIG. 2. In addition, the first control chamber 45 of the pilot stage valve 7 is connected on the downstream side to the second control chamber 47 via a re-flow channel 65, the re-flow channel 65 having a check valve 67 opening in flow direction to the second control chamber 47. The refilling of the second control chamber 47 is therefore not dependent on the pressure ratios in the second working chamber 15 or the restricting effect of the choke 55 in the second flow connection 31 between the second working chamber 15 and the second control chamber 47.

The check valve 67 prevents flow around the pilot stage valve 7 proceeding from the second working chamber 15. The damping medium flowing into the pilot stage valve 7 from the first working chamber 13 does flood the second control chamber 47 of the pilot stage valve 7, but it flows off into the second working chamber 15 via the second flow-off line 41 and passes the second flow connection 31 because the choke 55 in the second flow connection 31 has a greater flow resistance than the line-dependent flow resistance in the second flow-off line 41.

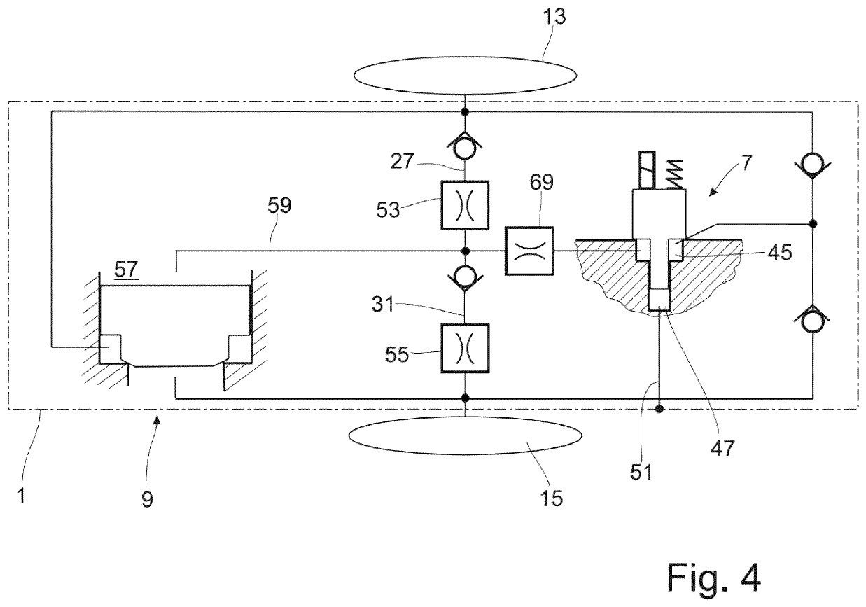

The damping valve device 1 according to FIG. 4 has at least two chokes 53; 69 in a hydraulic series connection in the first flow connection 27 from the first working chamber 13 to the pilot stage valve 7. The two chokes 53; 69 are connected at the control line 59 between the pilot stage valve 7 and the main stage valve 9. The basic principle of this damping valve device 1 is the same as that of the construction according to FIG. 1. The second choke 69 lowers the pressure level even further in the first control chamber 45 compared with the second control chamber 47 in the pilot stage valve 7. At the same time, the pressure level in the control chamber 57 of the main stage valve 9 can be predetermined relative to the compression of the working chambers 13; 15 by using the first of the two chokes 53; 69. If the first choke 53 displays a low restricting effect, a higher closing pressure occurs in the control chamber 57 of the main stage valve 9, and vice versa. The pressure in the first control chamber 45 is influenced by the second choke 69 to adapt the lift force on the pilot stage valve 7 to a predetermined damping force characteristic of the damping valve device 1. The choke 53 initially active from the first working chamber 13 in flow direction essentially determines the trending closing force in the control chamber 57 of the main stage valve 9 and the second choke 69 via the pressure in the first control chamber 45 of the pilot stage valve 7 at which pressure in the working chamber 13 and, therefore, in the first control chamber 45 the desired lift force is provided at the pilot stage valve 7 in order to adjust the damping force that can be generated by the main stage valve 9. The refilling of the second control chamber 47 is carried out as in FIG. 1 choke-free via the third flow connection 51 from the second working chamber 15.

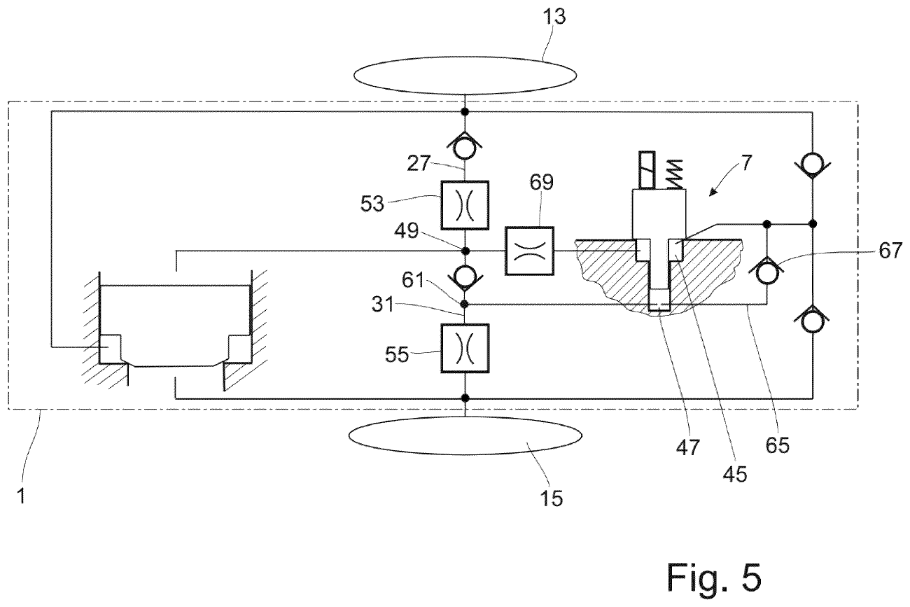

The construction of the damping valve device 1 according to FIG. 5 substantially corresponds to the construction according to FIG. 4. In contrast, as has already been described in connection with FIG. 3, a refilling channel 65 is used in connection with the check valve 67.

FIG. 4 shows that both flow connections 27; 31 have, respectively, a first choke 53; 55 for the control line 59 to the main stage valve 9 and a common second choke 69 for the pilot stage valve 7. In FIG. 5, the two flow connections 27; 31 from the two working chambers 13; 15 to the first control chamber 45 of the pilot stage valve 7 are also connected to a common second choke 69. However, the second control chamber 47 of the pilot stage valve 7 is additionally, and therefore in contrast to the embodiment according to FIG. 4, downstream of the choke 55 in the second flow connection 31. Consequently, in this damping valve device 1, the two control chambers 45; 47 are acted upon with a reduced control pressure during an incident flow proceeding from the second working chamber 15. Accordingly, the lift force at the pilot stage valve 7 is further reduced and the trending damping force characteristic is changed slightly toward a higher damping force compared with the embodiment according to FIG. 4. Here also, the re-flow channel 65 is used in connection with the check valve 67.

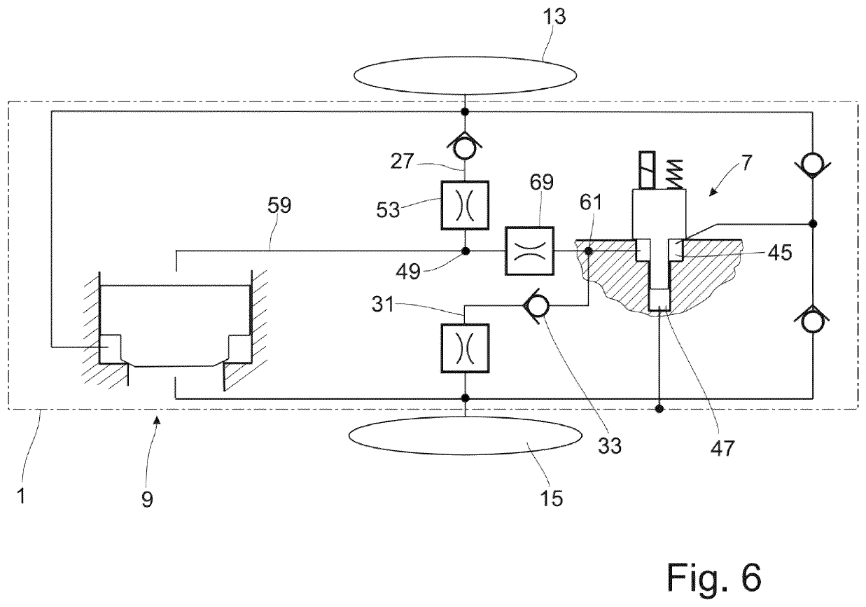

The damping valve device 1 according to FIG. 6 comprises a first flow connection 27 with a series connection of two chokes 53; 69 between the first working chamber 13 and the first control chamber 45 of the pilot stage valve 7. The first port 49 which connects the first flow connection 27 to the control line 59 to the main stage valve 9 is located after the first choke 53 in flow direction proceeding from the first working chamber 13. There follows in flow direction, first, the control chamber 45 of the pilot stage valve 7, the second choke 69 for further reducing the control pressure in the first control chamber 45. The second port 61 for the connection of the second flow connection 31 to the first control chamber 45 of the pilot stage valve 7 is located between the second choke 69 and the first control chamber 45. Accordingly, the damping medium proceeding from the second working chamber 15 flows only through the one choke 55, the opening second check valve 33 and the second port 61 until reaching the first control chamber 45 of the pilot stage valve. Consequently, the pressure level in the first control chamber 45 in this incident flow direction is higher than during an incident flow from the first working chamber 13 via the series connection of the two chokes 53; 69. The second control chamber 47 of the pilot stage valve 7 is acted upon directly by the second working chamber 15 as in FIG. 1. In this variant, the difference in achievable damping force of the damping valve device between the two incident flow directions is appreciably greater than in the variant of the damping valve device 1 according to FIG. 5.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An adjustable damping valve device for a vibration damper comprising:
a main stage valve;
a pilot stage valve for hydraulic control of the main stage valve;
a check valve arrangement configured to rectify of a control volume flow proceeding from working chambers of the vibration damper to the pilot stage valve; and
a pilot stage valve body of the pilot stage valve has a first pressurized surface D₁ for an incident flow from a first working chamber and a second pressurized surface D₂ for an incident flow from a second working chamber.

2. The adjustable damping valve device according to claim 1, wherein the first pressurized surface D₁ and the second pressurized surface D₂ are loaded during an incident flow proceeding from one of the first and second working chambers.

3. The adjustable damping valve device according to claim 1, wherein the pilot stage valve has a first control chamber for the first pressurized surface D₁ and a second control chamber for the second pressurized surface D₂, which control chambers are hydraulically separated.

4. The adjustable damping valve device according to claim 1, wherein the pilot stage valve body has a step profile, wherein the first pressurized surface D₁ is formed by a step.

5. The adjustable damping valve device according to claim 3, wherein each of the first and second working chambers have a separate flow connection with at least one choke point to a respective connected control chamber.

6. The adjustable damping valve device according to claim 1, wherein a first flow connection from a first working chamber to the pilot stage valve has at least two chokes in series, wherein a first choke of the at least two chokes is connected to a control line between the pilot stage valve and the main stage valve.

7. The adjustable damping valve device according to claim 3, wherein the second control chamber is connected choke-free to the second working chamber.

8. The adjustable damping valve device according to claim 3, wherein the second control chamber is refilled from the second working chamber via a choke of a second flow path.

9. The adjustable damping valve device according to claim 6, wherein the two flow connections have a first choke for the control line to the main stage valve and a second choke for the pilot stage valve.

10. The adjustable damping valve device according to claim 3, wherein respective flow connections of the first and second working chambers to the first control chamber of the pilot stage valve are connected at a common second choke.

11. The adjustable damping valve device according to claim 3, wherein the first control chamber is connected to the second control chamber on a downstream side via a re-flow channel, wherein the re-flow channel has a check valve opening in a direction of the second control chamber.
